(19) United States
(12) Patent Application Publication
(10) Pub. No.: US 2024/0331336 A1
(43) Pub. Date: Oct. 3, 2024

(54) MULTI-SOURCE OBJECT DETECTION AND ESCALATED ACTION

(71) Applicant: Vivint, Inc., Provo, UT (US)

(72) Inventor: Erik Stephen Pfeiffer, Lehi, UT (US)

(73) Assignee: Vivint, Inc., Provo, UT (US)

(21) Appl. No.: 18/617,156

(22) Filed: Mar. 26, 2024

Related U.S. Application Data
(60) Provisional application No. 63/492,431, filed on Mar. 27, 2023.

(51) Int. Cl. G06V 10/25; G06T 7/20; G06V 20/52

(52) U.S. Cl. CPC G06V 10/25; G06T 7/20; G06V 20/52; G06V 2201/07

(57) ABSTRACT

Presented herein are system and methods for monitoring a premises. The system and methods can include one or more sensor devices, including one or more image capture devices and one or more processors. The systems and methods can detect, using the one or more sensor devices, the presence of an entity within a first zone of the environment. The systems and methods can determine that the entity corresponds to one or more criteria and determine a first threshold duration based at least in part on the one or more criteria that correspond to the entity. The systems and methods can further determine a duration the entity remains in the first zone after detection by the one or more sensor devices and execute a deterrence action based on the duration and the first threshold duration.

### RELATED APPLICATIONS

This application claims priority under 35 U.S.C. § 119(e) to U.S. Provisional Patent Application No. 63/492,431, titled “MULTI-SOURCE OBJECT DETECTION AND ESCALATED ACTION,” filed Mar. 27, 2023, which is hereby incorporated herein by reference in its entirety to the extent such subject matter is not inconsistent herewith.

### TECHNICAL FIELD

This application generally relates to systems that monitor premises, and more specifically to security and/or home automation systems which include a plurality of sensors to monitor a premises.

### BACKGROUND

Cameras and other sensors are often used to monitor premises, including as part of a security system protecting a home or other premises. One or more entities may enter into areas within a field of view of a camera, motion sensor, or other sensor of a security system protecting a home. An unfriendly entity may perpetrate an event, such as a burglary, solicitation, vandalization, or other undesirable event. However, camera footage captured by a camera but not viewed by a user cannot be used by the user to prevent harmful activities. As an example, a homeowner cannot practically constantly monitor their security camera feeds to identify and prevent package theft. Presently available systems attempt to take actions based on video footage, but can mistakenly take incorrect or undesired actions, or may be limited in actions because of low confidence of accurate interpretation or processing of image data.

### BRIEF DESCRIPTION OF THE DRAWINGS

The accompanying drawings constitute a part of this specification, illustrate an embodiment, and, together with the specification, explain the subject matter of the disclosure.

FIG. 1 illustrates an example system according to one embodiment of the present disclosure.

FIG. 2 is a flow diagram illustrating operations of a method for detecting an entity and taking an action, according to one embodiment of the present disclosure.

FIG. 3 is a flow diagram illustrating operations of a method for detecting an entity and taking a deterrence action, according to one embodiment of the present disclosure.

FIG. 4 is a diagram of an example security system according to one embodiment of the present disclosure.

### DETAILED DESCRIPTION

The present application discloses systems that monitor premises, such as security and/or home automation systems. While monitoring premises, disclosed embodiments may detect an entity and take an action based on whether the entity is in a zone. The action may be escalated if the entity has certain characteristics (or meet certain criteria) and/or remains in the zone beyond a threshold length of time. In some embodiments, an entity can include a person detected by one or more sensor devices, such as a person approaching an entryway of a home. Additionally, in some embodiments, one or more sensor devices can include one or more cameras, radar sensors, image sensors, microphones, doorbell cameras, LIDAR sensors, infrared sensors, and the like, as described in greater detail below. And in some embodiments a threshold duration can include a duration of time that an entity may be present (e.g., within a zone, area, or region) inside the field of view of one or more sensors before an action is executed in response to the entity's presence. More specifically, a threshold duration can include the amount of time that a person can be detected by a security system before the security system will act, such as by turning on a light, playing a sound, and the like.

For example, in some embodiments, one or more sensors may include a camera with radar and a microphone. A first entity may be a person. A first zone may be a lawn in front of a home. In these embodiments, the person is detected by the sensors walking along a street in front of the home and within the field of view of the camera, but not within the first zone. With the person located outside the first zone the security system can wait for the person to remain within the field of view of the sensors for a default amount of time before it executes an action, such as notifying a user. Additionally, in these examples, if the sensors detect that the person turns and enters the first zone by walking on the lawn, the security system may determine a shortened duration that the person may remain on the lawn before the security system executes an action, such as playing a sound, activating one or more lights, and/or notifying a user.

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Disclosed herein are systems and methods for one or more sensor devices to capture sensor data in an environment. Some embodiments can include an apparatus that comprises: one or more sensor devices, including one or more image capture devices (e.g., to capture image data of an environment), and one or more processors. The one or more processors can be configured to detect, using the one or more sensor devices, the presence of an entity within a first zone inside a field of view of the one or more image capture devices and determine that the entity corresponds to one or more criteria. The one or more processor can be configured to determine a first threshold duration based at least in part on the one or more criteria that correspond to the entity. The one or more processors may be further configured to determine a duration the entity remains in the first zone after detection by the one or more sensor devices. The one or more processors may be further configured to execute a deterrence action based on the duration and the first threshold duration.

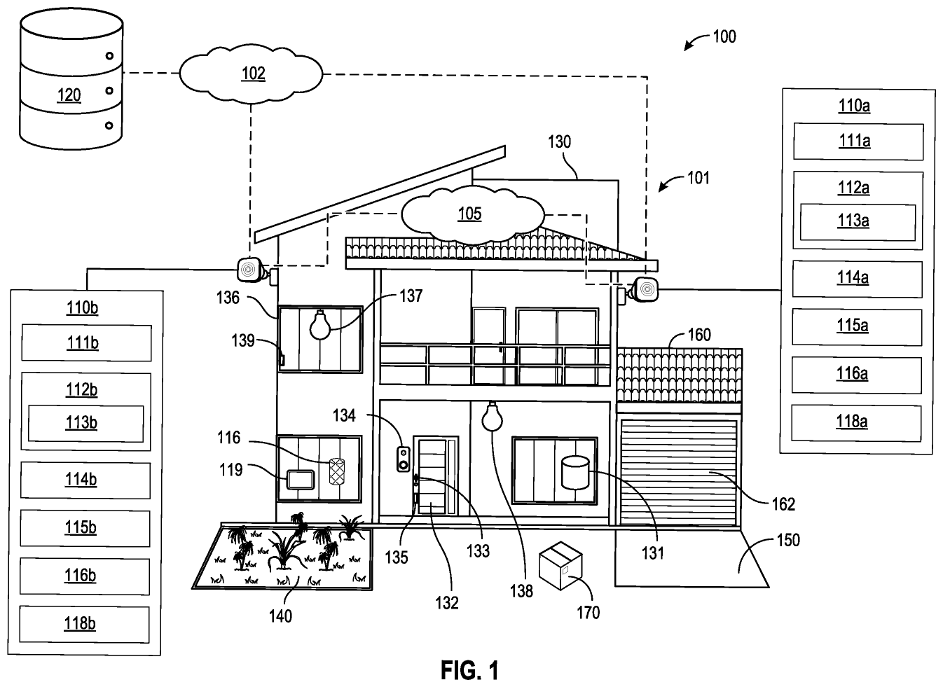

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave®connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a depth sensor 114a (e.g., radar sensor 114a), a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 11a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 102, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116 The speaker(s) 116 may be independent from other devices or integrated therein. For example, the camera(s) may include one or more speakers 116 (e.g., speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio from the speaker(s) 116 located at the building 130. In an embodiment, one or more sounds may be output in response to detecting the presence of a human within an area. For example, the controller may cause the speaker 116 may play one or more sounds selected to deter a detected person from an area around a building 130, environment 100, and/or object. The speaker 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller 106 may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?,” a female with a country accent saying “hello there,” a dog barking, a teenager saying “don't you know you're on camera?,” and/or a man shouting “hey!” or “hey you!,” or the like.

In some implementations, the security system 101 and/or the one or more security devices may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computer 125 may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101 and/or the one or more security devices, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101 and/or the one or more security devices may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101 and/or the one or more security devices may play a primary sound layered and/or overlapping with one or more secondary, tertiary, and/or background sounds, varying the sounds and/or the combination from one or more previously played sounds and/or combinations, or the like.

The security system 101 and/or the one or more security devices, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101 and/or the one or more security devices, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101 and/or the one or more security devices may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101 and/or the one or more security devices may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101 and/or the one or more security devices are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

Some implementations of the system 101 may include one or more sensor devices (e.g., cameras 110, radar sensors 114, image sensors 115, microphones 118, doorbell camera 134, LIDAR sensors, time-of-flight sensors, proximity sensors, etc.) to capture sensor data in an environment; and one or more processors configured to collect, using a first sensor device of the one or more sensor devices, first sensor data of an object in the environment. In some examples, of the system 101, the first sensor data may include image data collected by one or more image capture devices (e.g., cameras 110, image sensors 115, doorbell camera 134, etc.) of the one or more sensor devices included in the system 101. The one or more processors may be configured to collect, using a second sensor device of the one or more sensor devices, second sensor data of the object. In some examples, the second sensor data may be non-image data of the object, such as sensor data collected by the radar sensors 114, microphones 118, and other non-imaging sensor devices of the one or more sensor devices (e.g., LIDAR sensors, time-of-flight sensors, proximity sensors, etc.).

The security system 101 can determine, using a first machine-learning model, and based on the first sensor data of the object, a first correlation (e.g., a probability) that the object corresponds to an entity category (or entity classification) of a set of entity categories (or a set of entity classifications). In some examples, the system 101 can determine, using a second machine-learning model, and based on the second sensor data of the object, a second correlation that the object corresponds to the entity category. In some examples, the system may designate, based at least in part on the first correlation and the second correlation, the object is an entity of the entity category and determine, based on the sensor data (e.g., collected by the one or more sensor devices), one or more criteria of the entity (e.g., identity, location, posture, appearance, height, gait, appearance, weapons, etc.). And in one example, the system 101 can execute one or more actions based on the entity category and the one or more criteria (e.g., turn on one or more lights, play one or more audio signals via the speakers 116, notify a user of the system 101, as described in greater detail below).

In some examples, the first machine-learning model can be trained by applying the first machine-learning model on historical data including image data that corresponds to the entity category. For example, the first machine-learning model can be trained using image data known to depict a person (e.g., a home occupant). Additionally, in some examples, the second machine-learning model can be trained by applying the second machine-learning model on historical data including sensor data that is not image data and that corresponds to the entity category. For example, the second machine-learning model can be trained using radar sensor data of an object known to be a person, which may include one or more criteria that are known to correspond to the object for which the radar sensor data was collected.

In some examples, the system 101 can determine, using a third machine-learning model, and based on the first and second sensor data, that the object corresponds to an entity profile. For example, the system 101 can determine that the entity corresponds to an entity profile of a known entity such as a home occupant, a family member, a neighbor, a pet or the like. Alternatively, in other examples, the system 101 can determine that the object corresponds to an entity profile of a known, but high-threat, entity such as an entity subject to restraining order, a known criminal, or a person identified by the user (e.g., via the user interface 119).

In some examples, the third machine-learning model of the system 101 can be trained by applying the third machine learning model on historical data including image data of one or more persons associated with the entity profile. For example, the third machine-learning model may be automatically trained using image data of a home occupant. In one example, the system 101 can include one or more processors that are further configured to determine, using the first machine-learning model, based on the first sensor data of the object, and for each entity category in the set of entity categories, a first correlation that the object corresponds to the entity category. For example, the system 101 can determine a first correlation that an object corresponds to an entity category for each entity category in a set of entity categories including at least the following entity categories: known person, unknown person, animal, or inanimate object.

In one example the system 101 can determine, using a second machine-learning model, based on the second sensor data of the object, and for each entity category in the set of entity categories, a second correlation that the object corresponds to the entity category. For example, the system 101 can determine a second correlation that an object corresponds to an entity category for each entity category in a set of entity categories, including at least the following entity categories: known person, unknown person, animal, or inanimate object.

In some examples, the system 101 can designate the object to be the entity of the entity category based at least in part on each of the first correlation, the second correlation, and a matrix lookup table. In one example, designating the object to be the entity of the entity category can be based at least in part on a first accuracy value used to scale the first correlation and a second accuracy value used to scale the second correlation, and the first accuracy value corresponds to an average accuracy of the first sensor device (e.g., an average accuracy of the cameras 110) and the second accuracy value corresponds to an average accuracy of the second sensor device (e.g., an average accuracy of the radar sensors 114). For example, in some embodiments, the matrix lookup table can map each weight, of a plurality of weights (accuracy values, etc.), to a correlation, of a plurality of correlations (e.g., probabilities, associations, values, etc.) and a corresponding entity category of the set of entity categories. Stated differently, a given correlation that an object corresponds to an entity category can be weighted, which may both be identified using a matrix lookup table (e.g., an array, function, mapping, etc.)

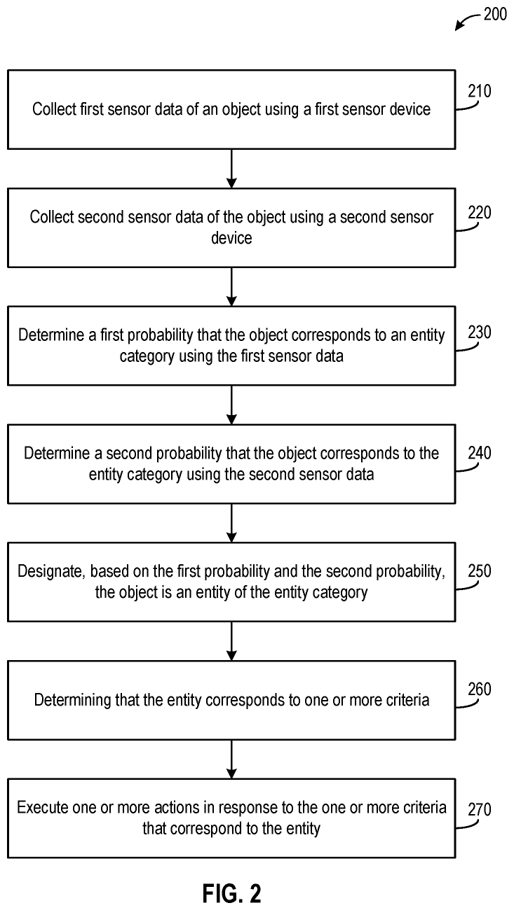

In one example, designating the object to be the entity can be based at least in part on a determination that the first probability and the second correlation each exceed a threshold correlation. Additionally, in some examples, the second sensor data of the object is data other than image data (e.g., non-image data), as described in greater detail below with reference to FIG. 2.

In some examples, the one or more criteria that correspond to the entity are one or more behaviors of the entity. Additionally, in some examples, the one or more behaviors of the entity include one or more of a velocity of the entity, a posture of the entity, and a distance between the entity and a region of interest within the environment. In some examples, a region of interest includes one or more of a package, a vehicle, a mailbox, a sensor, a door, and a window.

In another example, the system 101 can include one or more sensor devices to capture sensor data in an environment and one or more processors executing a machine-learning model to determine, based on first sensor data of the object, a first correlation that the object corresponds to an entity category of a plurality of entity categories, wherein the first sensor data is captured using a first sensor device of the one or more sensor devices, and wherein the first sensor data of the object comprises image data. Additionally, the one or more processors can be configured determine, based on second sensor data of the object, a second correlation that the object corresponds to the entity category, wherein the second sensor data is captured using a second sensor device of the one or more sensor devices, and can define, based at least in part on the first prob correlation ability and the second correlation, the object as an entity of the entity category. The one or more processors can further determine, based on the sensor data and the entity category, one or more criteria of the entity and based on one or more criteria of the entity, execute one or more actions (e.g., as described in greater detail below).

In some embodiments, the system 101 can include one or more sensor devices, including one or more image capture devices to capture image data of an environment and one or more processors configured to detect, using the one or more sensor devices, the presence of an entity within the environment, and potentially within a first zone inside a field of view of the one or more image capture devices. The one or more processors can be further configured to determine that the entity corresponds to one or more criteria. The one or more processors can use a machine learning model to determine the entity corresponds to the one or more criteria. The one or more processors can be further configured to determine a first threshold duration based at least in part on the one or more criteria that correspond to the entity. The one or more processors can use a machine learning model to determine the first threshold duration. In some embodiments, the first threshold duration may be shortened based on the one or more criteria of the entity indicating suspicious behavior or presence within one or more zones and/or near one or more regions of interest. Additionally, the one or more processors can be further configured to determine a duration the entity remains in the first zone after detection by the one or more sensor devices and execute a deterrence action based on the duration and the first threshold duration.

In one embodiment, one or more processors of the system 101 can be further configured to identify a default duration based at least in part on the first zone, wherein the first threshold duration is less than and/or shorter than the identified default duration.

Additionally, in some embodiments, the one or more processors of the system 101 can be further configured to detect, using the one or more sensor devices, the presence of one or more additional entities within the first zone. The one or more processors can be further configured to determine that the one or more additional entities correspond to one or more criteria and to determine that the one or more additional entities have remained in the first zone for the first threshold duration after detection by the one or more sensor devices. Moreover, the first threshold duration can also be determined based on the detected one or more additional entities and the one or more criteria that correspond to the one or more additional entities.

In some embodiments, the one or more processors of the system 101 can be further configured to detect, using the one or more sensor devices, the presence of the entity within a second zone within the environment, and potentially inside the field of view of the one or more image capture devices, and determine a second threshold duration based on parameters of the second zone (e.g., characteristics, settings, etc.) and the one or more criteria that correspond to the entity (e.g., based on the fact that the entity is within the second zone, which may be different from, overlapping with, or encompassed by the first zone, described above). Additionally, the one or more processors can execute the deterrence action based on the duration meeting the second threshold duration, and the second threshold duration can be shorter than the first threshold duration.

In some embodiments of the system 101 the determined one or more criteria that correspond to the entity include a behavior of the entity. Additionally, in some embodiments of the system 101 the determined one or more criteria that correspond to the entity include a distance between the entity and a location. And, in some of those embodiments, the location (e.g., for which a distance to the entity is determined) is the location of one or more of the one or more sensor devices. Further, in some embodiments, the location can be within the second zone. Additionally, in some embodiments, the location can be an entrance to a dwelling.

In one embodiment, the one or more criteria that correspond to the entity include a distance between the entity and an object. And in one embodiment, the one or more criteria that correspond to the entity include a weapon in the entity's possession. Further, in one embodiment, the one or more criteria that correspond to the entity include a direction of travel of the entity. And in some embodiments, the determined one or more criteria that correspond to the entity include a velocity of the entity.

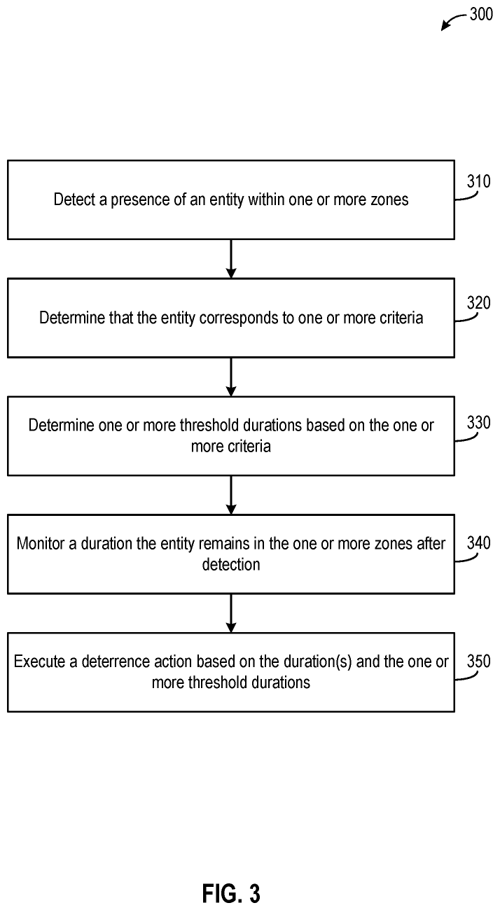

In some embodiments of the system 101, to execute the deterrence action, the one or more processors of the system 101 can be further configured to execute a default deterrence action based on the duration meeting the second threshold duration and to execute a first escalated action based on the duration meeting the first threshold duration (e.g., as explained in greater detail with reference to FIG. 3, below).

Additionally, in some embodiments of the system 101, to execute the deterrence action, the one or more processors of the system 101 (e.g., the cameras 110, the smart home device 131, and/or the sever 120, etc.) are further configured to execute a second escalated action based on the duration meeting a default duration.

FIG. 2 is s a flow diagram illustrating operations of a method 200 for detecting an entity and taking an action, according to one embodiment of the present disclosure. The method 200 can be performed by one or more components of the security system 101, including, for example, the first camera 110a, the second camera 110b, the radar sensors 114, the image sensors 115, the microphones 118, the doorbell camera 134, and the like, but is not limited thereto. In some implementations, one or more of the steps may be performed by the processors 111a, 11b and the server 120, but is not limited thereto. In other embodiments, the method 200 may be performed by a different processor, server, or any other computing device. For instance, one or more of the steps may be performed via a cloud-based service including any number of servers, which may be in communication with the security system 101 and any of its individual components. Although the steps are shown in FIG. 2 having a particular order, the steps may be performed in any order. In some instances, some of these steps may be optional. The method 200 may be executed to improve the processing of sensor data collected from sensors used to monitor a premises, including as part of a home security system.

Sensor data can be collected 210, using a first sensor device of one or more sensor devices, including, for example, first sensor data of an object. In some examples, the first sensor data of the object can include image data of the object, such as image data captured by one or more image capture devices of the one or more sensor devices. For example, the first sensor data of the object can include one or more images of the object as collected by the first camera 110a, the second camera 110b, or the image sensors 115.

Sensor data of the object can be collected 220 using a second sensor device of the one or more sensor devices, including, for example, second sensor data of the object. In some examples, the second sensor data of the object can differ from the first sensor data in that the second sensor data of the object is not image data. For example, the second sensor data can include sensor data collected by one or more radar sensors (e.g., radar sensors 114a, 114b), one or more indirect time of flight sensors (e.g., using infrared frequencies), one or more direct time of flight sensors (e.g., using infrared frequencies), one or more LIDAR sensors, one or more structured light sensors, and one or more microphones (e.g., microphones 118a, 118b).

In one example, the second sensor data of the object can be a point cloud of the object collected by one or more of the radar sensors 114a, 114b. In one example, the first sensor data can be collected by one or more imaging sensors (e.g., the cameras 110, described above with reference to FIG. 1) and the second sensor data can be collected by one or more additional sensors, including image sensors, cameras, radar sensors, one or more LIDAR sensors, one or more indirect or direct time of light sensors, among others. As another example, the first sensor data may be image data of the object collected by the image sensors 115 and the second sensor data of the object can be audio data of the object collected at the same time, or substantially the same time, as the first sensor data is collected.

As described in greater detail below, in some implementations, separate and/or independent likelihoods can be determined regarding an object (e.g., that the object is within an area, that the object is an entity, that the object corresponds to a profile, etc.) based, at least in part, on the first and second sensor data (e.g., examples of method 200 can include processing data separately, using separate machine-learning and/or other artificial intelligence, using separate metrics, or the like). The method 200 may include combining sensor data, likelihoods, determinations, or the like from multiple sensors such as image sensors 115, the radar sensors 114, and/or the microphones 118 for a single determination regarding an object (e.g., whether the object is within an area, whether the object is an entity, etc.) in order to perform an action relative to the object. For example, the cameras 110 and/or each of the cameras 110 may use a voting algorithm and determine that the object 170 is present within an area in response to most of the sensor devices, or of each of the sensor devices, determining that the object 170 corresponds to the entity category.

In some examples, the method 200 can determine 230, using a first machine-learning model, and based on the first sensor data of the object, a first correlation that the object corresponds to an entity category of a set of entity categories. For example, the one or more processors can execute a first machine-learning model that receives the first sensor data as its input and, as an output, identifies the first correlation that the object corresponds to the entity category. In some examples, the first machine-learning model may be trained and utilized to identify, lookup, determine, generate and/or otherwise provide the first correlation that indicates the object corresponds to, and/or is associated with, the entity category. The machine-learning model may be trained by applying the machine-learning model on historical data including sensor data of a variety of different entities and/or persons, which correspond to various entity categories (e.g., using sensor data of one or more different persons in various clothing, one or more pets, one or more packages, and the like). In some implementations, determining 230 the first correlation that the object corresponds to the entity category may include detecting a presence of a person. Additionally, in some examples determining 230 the first correlation that the object corresponds to the entity category may be based, at least in part, on identifying one or more characteristics of the object including, for example, whether the object is a package, animal, or person, and, if a person, identifying the person's clothing, height, girth, weight, hair color, gait, profession, identity, and/or other characteristics.

In some examples, the first correlation can be a probability, a percentage, an indication, a degree or level of relation, a correspondence, or even simply the name of the category, an abbreviation, a code that correlates (or corresponds) to the category, among other examples. More specifically, the first correlation can include an indication that the first sensor data corresponds to, or is associated with, the entity category (e.g., a neighbor, home occupant, pet, or the like). Stated differently, the method 200 can include using a machine learning model (e.g., the first machine learning model) to identify or otherwise determine a first correlation or correspondence between the first sensor data, and/or an entity captured in the first sensor data, and a known entity category (e.g., a home occupant category).

In an example, a processor executing the first machine-learning model may determine 230 the first correlation as a first correlation and it may further determine that the first correlation is greater than a threshold (e.g., a first probability greater than or equal to 51 percent). For example, the first machine learning model may determine a first correlation, e.g., that the object corresponds to an entity category, using image data depicting that the object is a person wearing black pants and a black shirt. In one example, a processor executing the first machine-learning model may determine a first correlation, and/or a first probability, that the object corresponds to a mail carrier, or a package delivery entity category based on one or more additional objects present in the environment (e.g., based on the presence of a delivery truck, one or more packages, etc.)

In some examples, the first machine learning model may determine 230 a first correlation that the object corresponds to an animal entity category, such as a homeowner's pet. In another example, a processor executing the first machine-learning model may determine 230 a first correlation, and/or a first probability, that the object corresponds to a male teenager entity category. In yet another example, a processor executing the first machine-learning model may determine 230 a probability that the object corresponds to a specific person (e.g., a profile and/or identity) entity category using facial recognition and/or other characteristics.

The first correlation that the object corresponds to an entity category may be determined 230, at least in part, by determining one or more actions associated with, and/or performed by, the object. In one example, a processor executing a first machine-learning model may determine that the object is a person and may further determine that the person is attempting to hide from one or more sensor devices (e.g., a doorbell camera). In another example, a processor may execute the first machine-learning model to determine 230 a first correlation that the object corresponds to a burglar entity category based, at least in part, on a determination that the object has passed by a house multiple times.

In yet another example, one or more processors may execute the first machine-learning model to determine 230 a first correlation, and/or first probability, that the object corresponds to a burglar entity category based on a determination that the object is a person looking in the windows of a house. In another example, the one or more processors may execute the first machine-learning model to determine 230 a first correlation that the object corresponds to a package entity category based on a determination that no actions are associated with the object (e.g., a determination that the object is physically inert and/or stationary during one or more portions of sensor data).

The entity categories of the set of entity categories can include one or more categories, types, examples, or classes of objects and/or entities that may be present within the environment. For example, the set of entity categories can include each of the following entity categories: packages, animals, pets, home occupants, delivery persons, family members, children, neighbors, known friends, unfamiliar persons, trespassers, burglars, inanimate objects, and unknown entities, among others.

In some examples, the object may correspond to more than one entity category and need not be limited to a single entity category. For example, the first machine-learning model may determine 230 a first correlation that indicates an object may correspond to both the unfamiliar persons category and the burglar category. Additionally, in some examples, the set of entity categories can include different iterations, types, degrees, and/or levels, associated with one or more of the examples listed above. For example, the set of entity categories can include a first burglar category, a second burglar category, a third burglar category and so on, where each burglar category corresponds to a different degree and/or type of severity, threat, or risk calculated, identified, and/or otherwise provided by the security system 101 or method 200.

The method 200 can include identifying or otherwise determining 230, using a second machine-learning model, and based on the second sensor data of the object, a second correlation that the object corresponds to the entity category (i.e., the same entity category indicated by the first correlation). For example, one or more processors (e.g., processors 111a, 111b) can execute a second machine-learning model, which may receive the second sensor data as input, and which may output (e.g., identify) the second correlation that the object corresponds to the entity category.

In some examples, as described above for the first correlation, the second correlation can be a probability, a percentage, an indication, a degree or level of relation, a correspondence, or even simply the name of the category, an abbreviation, a code that correlates (or corresponds) to the category, among other examples. More specifically, the second correlation can include an indication that the second sensor data corresponds to, or is associated with, the entity category (e.g., a neighbor, home occupant, pet, or the like). Stated differently, the method 200 can include using a machine learning model (e.g., the second machine learning model) to identify a second correspondence between the second sensor data, and/or an entity captured in the second sensor data, and a known entity category (e.g., a home occupant category).

In some examples, the second machine-learning model may be trained and utilized to determine or otherwise generate the second correlation (e.g., probability, likelihood, value, etc.) that the object corresponds to the entity category. The second machine-learning model may be trained by applying the second machine-learning model on historical data including sensor data of various persons, which correspond to various entity categories (e.g., objects that correspond to various entities, in a variety of clothing and in different settings). In some implementations, determining 240 the second correlation that the object corresponds to the entity category may include detecting a presence of a person. Determining 240 the second correlation that the object corresponds to the entity category may be based, at least in part, on one or more characteristics of the object including, for example, size, position, shape, movement, sound, hair color, gait, and/or other characteristics.

In some examples, the second machine-learning model may determine 240 a second correlation that is greater than a threshold (e.g., a second probability greater than or equal to 51 percent) that the object corresponds to the entity category (e.g., the entity category of the first correlation, described above) using non-image data (e.g., sensor data that is not image data) of the object or sensor data that otherwise differs (e.g., in source or type) from the first sensor data described above (e.g., at 210). In one example, the second machine-learning model may determine a probability that the object corresponds to the entity category (e.g., a mail carrier or delivery person category) based on a presence of one or more additional objects in the environment (e.g., based on a presence of a delivery truck, one or more packages, etc.). In another example, the second machine-learning model may determine a probability that the object corresponds to a male teenager entity category. In yet another example, a processor executing the second machine-learning model may determine a probability that the object corresponds to a specific person (e.g., a profile and/or identity) entity category, including via facial recognition and/or other characteristics of the object.

The second correlation that the object corresponds to the entity category may be determined 240, at least in part, based on one or more actions performed by the object. In one example, a processor executing a second machine-learning model may determine that the object is attempting to hide from one or more sensor devices (e.g., a radar sensor). In another example, a processor may execute the second machine-learning model to determine the second correlation that the object corresponds to a burglar entity category based, at least in part, on a determination that the object has passed by a house multiple times. In yet another example, a processor may execute the second machine-learning model to determine a second correlation that the object corresponds to a burglar entity category based on a determination that the object is a person looking in a window of a house.

In one example, the method 200 designates 250, based at least in part on the first correlation and the second correlation, the object is an entity of the entity category. For example, some implementations may designate 250 the object as an entity of the home occupant entity category. In another implementation, the method 200 can designate 250 the object to be an entity only if each of the first correlation and the second correlation are greater than a specified threshold value (e.g., 50 percent, 75 percent, 80 percent, 90 percent, etc.). In yet another example, the method 200 can designate 250 the object to be an entity of the entity category based on an adjustment value of the first correlation or the second correlation, where the adjustment value reflects an average accuracy of the sensor devices used to collect the second sensor data.

In some implementations, the method 200 may designate the object 170 is an entity or corresponds to an entity category in response to all sensors individually determining that the object 170 is an entity or that the probabilities associated with each of the sensor devices indicates that the object 170 more likely than not corresponds to the entity category (e.g., a more conservative and/or less aggressive determination than a voting algorithm). In some implementations, the cameras 110 may determine that the object 170 is an entity in response to at least one sensor determining that the object 170 is an entity (e.g., a less conservative and/or more aggressive determination than a voting algorithm).

Additionally, in some implementations, the method 200 may designate the object 170 is an entity or corresponds to an entity category in response to an average probability, computed from the first correlation and the second correlation, that is greater than a threshold probability value. For example, the method 200 can, in some implementations, determine an average or total probability based on a weighted average or other computation (e.g., sum, multiplication, weighted average, etc.) of the first correlation that the object corresponds to the entity category and the second correlation that the object corresponds to the entity category. In that implementation, the weights applied to compute the weighted average may reflect the average accuracy of each sensor device used to collect the sensor data of each probability (e.g., a weight for the first correlation may reflect an average accuracy of the first sensor devices, such as the image sensors 115, used to collect the first sensor data from which the first correlation is determined, as explained above).

In one example, the method 200 determines 260, based on the sensor data, one or more criteria of the entity. For example, the method 200 can determine 260, based on the sensor data, one or more criteria of the entity, including that the entity is located within one or more regions of interest (e.g., proximate to a window, door, or other sensitive location). The one or more criteria may include whether the entity matches an existing entity profile (e.g., a home occupant, family member, friend, etc.). In some examples, the one or more criteria of the entity can include any of the movement, size, identity, age, appearance, location, sound, gait, and posture of the entity, but the one or more criteria are not limited thereto and may include other criteria not listed here.

Additionally, the method 200 can determine 260 one or more criteria of the entity based on sensor data collected by the one or more sensor devices that includes sensor data beyond the first sensor data and the second sensor data. For example, the one or more criteria of the entity can be determined based on additional image data of the entity that is collected after the first and second sensor data. In another example, the criteria of the entity can be determined based on additional sensor data collected by one or more additional sensor devices (e.g., third sensor data collected by a third sensor, such as a doorbell camera, door sensor, window sensor, etc.).

The method 200 can execute 270 one or more actions based on the entity category and the one or more criteria. In some examples, it can execute 270 one or more actions based on the severity or threat associated with the entity category and one or more criteria of the entity. For example, it may execute one or more actions of a relatively low severity for an entity that matches a known profile (e.g., home occupant or family member). In contrast, one or more actions of relatively greater severity may be executed where the entity category and the one or more criteria correspond to an increased threat to the premises (e.g., corresponding to a burglar or trespasser entity category, one or more criteria indicating the entity is holding a weapon or proximate to one or more regions of interest, etc.).

The one or more actions may include one or more actions executed to deter theft or other threatening behaviors (e.g., to prevent theft of a package, deter trespass, discourage unlawful entry into a home, etc.). In an example, the method 200 may include executing the one or more actions based on a determination that the movement of an object by the entity is a package theft or otherwise harmful or undesirable. The one or more actions may include actions performed by a variety of devices, such as components of the security system 101. In an example, the one or more actions may include turning a porch light on, turning a porch light off, emitting light and/or sounds from a doorbell, emitting light and/or sounds from a camera, turning on sprinklers, turning on or off interior lights, playing a sound on interior speakers, or other actions. Executing the one or more actions may include determining that a direction of movement of the entity is away from a building or a region of interest. In an example, the method 200 may include one or more actions based on one or more criteria that indicate that movement of a package by the entity is a theft based on the package being moved away from, or taken out of, one or more regions of interest.

In some examples, the method 200 can include collecting, using a first sensor device of one or more sensor devices, first sensor data of an object in an environment, wherein the first sensor data of the object comprises image data. In one example, the method includes collecting, using a second sensor device of the one or more sensor devices, second sensor data of the object in the environment. In some examples, the method can include determining, by a computer executing a first machine-learning model and based on the first sensor data of the object, a first correlation that the object corresponds to an entity category of a set of entity categories.

Additionally, in some examples, the method 200 can include determining, by a computer executing a second machine-learning model and based on the second sensor data of the object, a second correlation that the object corresponds to the entity category. In one example, the method can include designating, based at least in part on the first correlation and the second correlation, the object is an entity of the entity category, determining that the entity corresponds to one or more criteria; and in response to the one or more criteria that correspond to the entity, execute one or more actions.

The method 200 can further include determining, by a computer executing a third machine-learning model, and based on the first and second sensor data, that the object corresponds to an entity profile. Additionally, in some examples, the third machine-learning model can be trained by applying the third machine learning model on historical data including image data of one or more persons associated with the entity profile.

In one example, the first machine-learning model can be trained by applying the first machine-learning model on historical data including image data that corresponds to the entity category. Similarly, in some examples, the second machine-learning model can be trained by applying the second machine-learning model on historical data including sensor data that is not image data and that corresponds to the entity category.

In one example, the method can further include determining, using the first machine-learning model, based on the first sensor data of the object, and for each entity category in the set of entity categories, a first correlation that the object corresponds to the entity category. Similarly, in some examples the method can include determining, using a second machine-learning model, based on the second sensor data of the object, and for each entity category in the set of entity categories, a second correlation that the object corresponds to the entity category. In some examples of the method, designating the object to be the entity of the entity category is based at least in part on each of the first correlation, the second correlation, and a matrix lookup table. For example, in some embodiments, the method can include using a matrix lookup table that maps a plurality of weights (accuracy values, etc.) to a plurality of corresponding correlations (e.g., probabilities, associations, values, etc.) for each entity category in the set of entity categories. Stated differently, a given correlation that an object corresponds to an entity category can be weighted, which may both be identified using a matrix lookup table (e.g., an array, function, mapping, etc.).

For example, a first sensor (e.g., a camera) may be associated with a relatively high accuracy in identifying a correlation that an object is a person or similar entity category. However, the first sensor may, in some examples, be associated with a relatively low accuracy in identifying a correlation that an object is an animal or other non-human entity category (e.g., associated with a lower accuracy in identifying dogs from cats and other non-human entity categories). Accordingly, a correlation (e.g., a probability, value, score, etc.) that the object corresponds to a human entity category (e.g., a homeowner entity category) may be weighted more heavily (e.g., include a weight of relatively greater magnitude) than a weight applied for a correlation, and/or probability, that the object corresponds to an animal entity category, which may each be values identified using the matrix or matrix lookup table.

Similarly, in some examples, one or more radar sensors (e.g., sensor data collected via one or more radar sensors) may be relatively accurate, and weighted accordingly, in correctly identifying objects (e.g., radar sensor data) that correspond to a person entity category (e.g., identify a person approaching an entrance of a home). However, the one or more radar sensors may, in some examples, be less accurate in correctly identifying objects (e.g., radar sensor data) that correspond to a package (e.g., an inanimate entity category); accordingly, the matrix lookup table may be used to identify two different weights (e.g., a plurality of weights each having a different magnitude) to the corresponding correlations and/or probabilities identified using the one or more radar sensors for those entity categories (e.g., a person entity category vs. an inanimate object category).

In one example of the method, designating the object to be the entity of the entity category is based at least in part on a first accuracy value used to scale the first correlation and a second accuracy value used to scale the second correlation, and the first accuracy value corresponds to an average accuracy of the first sensor device and the second accuracy value corresponds to an average accuracy of the second sensor device.

In some examples of the method, designating the object to be the entity is based at least in part on a determination that the first correlation and the second correlation each exceed a threshold probability. Additionally, in some examples, the second sensor data of the object does not include image data. And in one example of the method, the one or more criteria that correspond to the entity are one or more behaviors of the entity. In some examples of the method, the one or more one or more behaviors of the entity can include one or more of a velocity of the entity, a posture of the entity, and a distance between the entity and a region of interest within the environment. In some examples of the method the region of interest includes one or more of a package, a vehicle, a mailbox, a sensor, a door, and a window.

FIG. 3 is s a flow diagram illustrating operations of a method for detecting an entity and deterring an undesirable action (e.g., theft) according to one embodiment of the present disclosure. The method 300 can be performed by one or more components of the system 101, including, for example, the cameras 110, the radar sensors 114, the image sensors 115, the microphones 118, the doorbell camera 134, and the like, but is not limited thereto. In some implementations, one or more of the steps may be performed by the processors 111a, 11b and the server 120, but is not limited thereto. In other embodiments, the method 200 may be performed by a different processor, server, or any other computing device. For instance, one or more of the steps may be performed via a cloud-based service including any number of servers, which may be in communication with the system 101 (e.g., via the network 102, the local network 105, etc.) and any of its individual components. Although the steps are shown in FIG. 3 having a particular order, the steps may be performed in any order. In some instances, some of these steps may be optional. The method 300 may be executed to improve the processing of sensor data collected from sensors used to monitor a premises, including as part of a home security and/or home automation system.

In some implementations, the method 300 can include detecting 310 a presence of an entity within one or more zones (e.g., a first zone, second zone, etc.) of an environment. In some examples, the method 300 can detect 310 a presence of an object identified or otherwise decided to be an entity according to method 200 or one or more of the steps described with reference to FIG. 2. For example, the method 300 can detect 310, by one or more sensor devices (e.g., one or more cameras 110, radar sensors 114, image sensors 115, microphones 118, doorbell cameras 134, and the like) a presence of an object decided to correspond to an entity category (e.g., an unknown person category) in a set of entity categories. The presence of the entity may be within a first zone, which can also be referred to as a first region, a first area, a first zone of interest, a first region of interest, a first area of interest, or the like. The presence of the entity can be detected within the first zone of interest via a plurality of sensor devices, including a plurality of sensor devices of a single type or category (e.g., two or more image sensors, two or more radar sensors, two or more LIDAR sensors, and the like). And, in some examples, the presence of the entity can be detected within the first zone via two or more sensors devices of different types or categories (e.g., an image sensor and a radar sensor; a doorbell camera, a microphone, and a LIDAR sensor; and other combinations of different sensor devices described herein).

A zone can correspond to a portion of a premises. The zone can be within the environment. The zone can be within the field of view of one or more sensors used to monitor the premises (e.g., one or more sensor devices described above with reference to the system 101 of FIG. 1, including the cameras 110, radar sensors 114, microphones 118, doorbell camera 134, and the like). For example, the zone can correspond to an area defined by a distance from a feature of a home. More specifically, in some examples, the zone can correspond to an area that is five feet or less from an entrance door of a home. In some examples, the zone can correspond to an area that is between two different distances from a feature of a home. For example, the zone can correspond to any location that is five to three feet from a door to a home. In some examples, the zone can correspond to any location within a specified distance from a home. For example, the zone may correspond to any location that is three feet or less from the home. In some examples, the zone may be limited to a field of view of one or more sensor devices (e.g., a field of view of the camera 110a). And, in some examples, the zone may extend beyond a single field of view of a sensor device and encompass at least portions of multiple different fields of view for multiple sensor devices. Two or more zones may at least partially overlap. A zone may be entirely contained within one or more other zones. A zone may entirely encompass one or more other zones.

The method 300 can further include determining 320, by one or more processors, that the entity corresponds to one or more criteria. For example, the method 300 can include determining that the entity corresponds to criteria for any of the following aspects of the entity: velocity, location, size, behavior, belongings, appearance, gait, vocalization, age, and the like. More specifically, in one example, the method 300 includes determining 320 that the entity corresponds to criteria indicating a distance between the entity and an entrance of a dwelling and one or more behaviors of the entity (e.g., holding a firearm or other weapon, peering about nervously, removing a package from a doorstep, etc.). Additionally, in some examples, the one or more criteria may correspond to whether the entity matches a profile for a known person or an occupant, which may affect one or more of the other steps shown in method 300 (e.g., prevent execution of a deterrence action, initiate one or more predetermined actions based on the profile matching the entity, and the like). A machine learning model may be used to determine 320 that the entity corresponds to the one or more criteria.

The method 300 can further include determining 330, by the one or more processors, one or more threshold durations according to or based at least in part on the one or more criteria that correspond to the entity. For example, the method 300 may determine, by the one or more processors, a first threshold duration that is a shortened duration based on one or more criteria for suspicious or threatening behavior of an entity. In some examples of the method 300, the first threshold duration can be shortened if the entity (e.g., an individual detected by one or more of the one or more sensor devices) corresponds to one or more suspicious criteria. For example, the first threshold duration may be shortened, in some examples, if the entity corresponds to one or more criteria that indicate the entity possesses a weapon, is located near one or more sensitive locations (e.g., a dwelling entrance, a window, a mailbox, a vehicle, etc.), is carrying one or more objects away from a premises (e.g., carrying a package off of a doorstep), and the like. The first threshold can be utilized to escalate a deterrence action, for example, based on a zone and criteria or characteristics of an entity detected in the zone. A machine learning model may be used to determine 330 the first threshold duration. A second threshold duration may also be determined 330. The second threshold may be shorter than the first threshold duration.

The method 300 may further include monitoring 340, by the one or more processors (e.g., smart home device 131, server 120, etc.), based on sensor data from the one or more sensor devices, a duration the entity remains in the one or more zones after detection by the one or more sensor devices. For example, the method 300 may monitor the duration that one or more sensor devices detect the presence of an entity within a first zone that includes an entry to a dwelling. More specifically, in one example, the method 300 can include monitoring 340, by one or more processors, based on radar sensor data (e.g., radar sensor data collected by radar sensors 114), the duration (e.g., the amount of time) that an entity (e.g., an unknown person, a person corresponding to one or more criteria of a suspicious or threatening person, etc.) remains within a first zone defined by a distance of three feet from a window of a dwelling. In this manner, escalation of a deterrence action can occur—to occur sooner according to the first threshold—based on a zone and criteria or characteristics of an entity detected in the zone. The example can further include the method 300 monitoring 340, by one or more processors, based on radar sensor data, a duration that the remains within a second zone, a third zone, and the like. The second zone may partially overlap, encompass, or be encompassed by the first zone. The third zone can similarly partially overlap, encompass, or be encompassed by one or more of the first zone.

The method 300 can further include executing 350 a deterrence action based on the duration(s) and the one or more threshold durations. For example, the method 300 can include executing one or more actions configured to deter a theft or other unwanted behavior or action. The deterrence action may include actions performed by a variety of devices, such as components of the system 101 described in greater detail above, with reference to FIG. 1. For example, the deterrence action may include turning a porch light on, turning a porch light off, emitting light and/or sounds from a doorbell (e.g., doorbell camera 134), emitting light and/or sounds from a camera, turning on sprinklers, turning on or off lights (e.g., an interior light 137, and/or an exterior light 138, etc.), playing a sound on speakers (e.g., interior and/or exterior speakers), or other actions. A machine learning model may be used to determine an appropriate deterrence action.

In some examples, the determined one or more criteria that correspond to the entity (e.g., as described above with reference to step 320) can include a behavior of the entity. And in one implementation the one or more criteria that correspond to the entity can include a distance between the entity and an object. In one implementation, the one or more criteria that correspond to the entity (e.g., described with reference to step 320) can include a weapon in the entity's possession. Moreover, in some implementations, the one or more criteria that correspond to the entity can include a direction of travel of the entity. Additionally, in some implementations, the one or more criteria that correspond to the entity can include a velocity of the entity. And, in some examples, the one or more criteria that correspond to the entity can include a distance between the entity and a location. For example, in some such implementations of the method 300, the one or more criteria can correspond to a distance between the entity and the location of one or more of the one or more sensor devices.

The method 300 can further include identifying, by the one or more processors (e.g., the cameras 110, the smart home device 131, the server 120, etc.), a default duration based at least in part on the first zone. In those implementations, the first threshold duration can be shorter than the identified default duration. For example, the first threshold duration can be three seconds and the identified default duration can be ten seconds. Accordingly, the method 300 includes escalating a deterrence action based on a zone and criteria or characteristics of an entity detected in the zone. In another example, the first threshold duration can be ten seconds and the default duration can be thirty seconds. However, the first threshold duration can be any suitable duration for the performance of the method 300 and the identified default duration can likewise be any suitable duration for the operation of the system 101 and the performance of the method 300. Additionally, in other embodiments, the first threshold duration may be greater than the identified default duration.

The method 300 can further include detecting, using the one or more sensor devices, the presence of one or more additional entities within the one or more zones. For example, the method 300 can including detecting, using the radar sensors 114, a presence of a second entity and a third entity within the first zone inside the field of view of the radar sensors 114 (e.g., a second entity and a third entity each within the field of view of the one or more image capture devices).

Relatedly, the method 300 can further include, in some examples, determining, by the one or more processors (e.g., the cameras 110, the smart home device 131, the server 120, etc.), that the one or more additional entities correspond to one or more criteria and determining, by the one or more processors, that the one or more additional entities have remained in the first zone for the first threshold duration after detection by the one or more sensor devices. Relatedly, in some implementations of the method 300, the first threshold duration (e.g., the first threshold duration described with reference to step 330) can be determined at least in part based on the detected one or more additional entities and the one or more criteria that correspond to the one or more additional entities.

In some examples, the method 300 includes detecting, using the one or more sensor devices, the presence of the entity within a second zone inside the field of view of the one or more image capture devices and determining, by the one or more processors, a second threshold duration based on parameters of the second zone and the one or more criteria that correspond to the entity. For example, in some implementations of the method 300 the one or more identified criteria that correspond to the second zone include the location (e.g., the location included in the one or more first criteria, as described in greater detail below) and wherein the location is within the second zone. In one example, the location (e.g., the location included in the one or more first criteria and/or one or more second criteria) can be an entrance to a dwelling.

Further, in some examples, the second threshold duration can be shorter than (e.g., less than) the first threshold duration and the one or more processors may execute the deterrence action (e.g., as described above with reference to step 350) based on the duration meeting the second threshold duration. For example, the one or more processors (e.g., smart home device 131, server 120, etc.) can execute a deterrence action (e.g., play an alarm sound via doorbell camera 134) that is escalated from, or more severe than, another deterrence action (e.g., turn on exterior light 138) based on the fact that the duration (e.g., the duration that the entity has been detected within the first zone) meeting the second threshold duration.

In some examples, the method 300 can further include executing a default deterrence action that can be based on the duration meeting a second threshold duration and can further include executing a first escalated action based on the duration meeting the first threshold duration. For example, the method 300 can include executing a default deterrence action (e.g., turning on the exterior light 138, shown in FIG. 1) that is based on the duration (e.g., the duration that the presence of the entity is detected in a first zone) and further executing a first escalated action, such as playing a siren sound via the doorbell camera 134, or one or more speakers 116 of the cameras 110, based on the duration (e.g., again, the duration that the presence of the entity is detected in a first zone) meeting the first threshold duration.

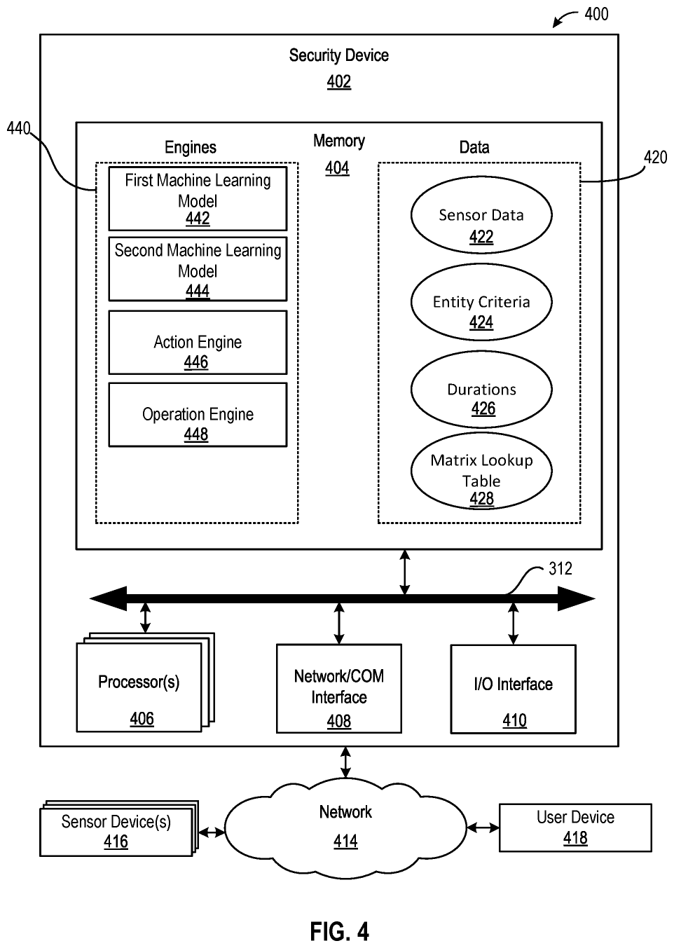

FIG. 4 illustrates a security system 400 in accordance with one embodiment of the present disclosure. The security system 400 includes a security device 402 and a one or more sensor devices 416. FIG. 4 includes a detailed view of the security device 402. As will be described, the security device 402 may be capable of many of the functions that may be associated with a security device (such as the cameras 110, the server 120, and/or the smart home device 131 shown in, and described with reference to, FIG. 1). Alternatively or additionally, the security device 402 may have data and engines configured to support functionalities of some embodiments of, e.g., a security system 400, such as the functionalities of the cameras 110, of FIG. 1.

The security device 402 may include a memory 404, one or more processor(s) 406, a network/COM interface 408, and an input/output (I/O) interface 410, which may all communicate with each other using a system bus 412.

The memory 404 of the security device 402 may include a data store 420. The data store 420 may include sensor data 422, a set of entity criteria 424, one or more entity durations 426, and one or more matrix lookup table(s) 428. The data store 420 may include data generated by, and/or transmitted to, the security system 400, such as by the one or more sensor devices 416. The data of the data store 420 may be organized as one or more data structures.

The sensor data 422 may include sensor data captured, recorded, and/or collected by the one or more sensor devices 416 (e.g., using the cameras 110, the radar sensors 114, the image sensor 115, the microphones 118, a doorbell camera, and the like, as shown in, and described with reference to, FIG. 1) and subsequently sent to the security device 402. The sensor data 422 may be stored as one or more images, videos, waveforms, point clouds, and/or other forms of collected sensor data 422. The sensor data 422 may be collected by the one or more sensor devices 416 and sent to the security device 402 as part of a training process for one or more machine learning models (e.g., to train the first machine-learning model to determine a threshold duration based on one or more inputs, such as criteria determined for an entity captured in sensor data 422). Alternatively or additionally, once the training process is complete or otherwise need not occur, sensor data 422 may be collected as part of determining and/or identifying (current) one or more entity criteria and/or entity locations associated with an entity detected by the security system 400 (e.g., as described above for the first machine learning model and the second machine learning model, with reference to FIG. 3). Additionally or alternatively, the security device 402 may itself perform the collection of the sensor data 422 (e.g., using one or more sensors of the I/O interface 410 of the security device 402, such as one or more image sensors, one or more radar sensors, and/or one or more microphones) attendant to training and/or identifying one or more entity criteria (e.g., identity, location, posture, appearance, height, gait, appearance, weapons, etc.), entity profile (e.g., a home occupant, family member, neighbor, pet, or the like), entity categories (e.g., an animal, child, adult, delivery person, or the like) and/or actions (e.g., a deterrence action) to be executed by the security system 400 (e.g., turn on one or more lights, play one or more sounds, notify one or more users, etc.), for an entity detected in at least a portion of the sensor data 422.

The set of entity criteria 424 may include one or more entity characteristics that may correspond to one or more entities detected and/or captured in the sensor data 422, including the sensor data collected by one or more of the sensor devices 416 and that was sent to the security device 402 for later use within the system 400. For example, the set of entity criteria can include identity, location, posture, appearance, height, gait, appearance, possessions and/or weapons, and the like.

The durations 426 may include, for example, a default duration (also referred to herein as a default threshold duration), a first threshold duration, a second threshold duration, and one or more different threshold durations that may correlate to one or more entity criteria determined for an entity detected by the one or more sensor devices 416 or the security device 402. For example, the security system 400 can determine that an entity corresponds to entity criteria for a suspicious person located within a first zone, which may be an area near a window or entrance of a home. Alternatively, in other examples, the security system 400 can determine that an entity corresponds to an entity category and/or entity profile of a known person (e.g., homeowner, family member, neighbor, and the like), which may correlate with, and/or form part of, the entity criteria 426 of the detected entity. The entity criteria 426 may also include voice data, image data, and the like that are associated with one or more entities (e.g., one or more known entities, such as homeowners/occupants, family members, and the like).

The matrix lookup table 428 may include information, mappings, weights, and/or correlations provided to the security device 402 (e.g., during a training process for one or more machine learning models) that enable the security device 402 to determine, for an entity and/or sensor data (e.g., an entity captured by, or reflected in, sensor data captured by the one or more sensor devices 416), one or more entity criteria (e.g., identity, location, posture, appearance, height, gait, appearance, weapons, etc.), and/or associated threshold durations. For example, the matrix lookup table 428 may be provided to the security system 400 and/or it may be determined using previously captured, and/or received, sensor data (e.g., a portion of sensor data 422 provided specifically for a training process performed for one or more machine-learning models 442, 444, 446 of the security device 402). In some embodiments, the matrix lookup table 428 may have been provided to the security device 402 via the network 414, user device 418, and/or I/O interface 410. In some examples, if the matrix lookup table 428 is needed at, and/or used by, another device of the security system 400, such as at the one or more sensor devices 416, it may be communicated from the security device 402 to the one or more sensor devices 416 via the network 414.

In addition to the data store 420, the memory 404 of the security device 402 may further include one or more engines 440 configured to perform one or more of the functionalities described herein. The engines 440 may include a first machine learning model 442, a second machine learning model 444, an action engine 446, and an operation engine 448.

The first machine-learning model 442 may receive, utilize, and/or process sensor data collected by one or more sensor devices (e.g., using one or more sensor devices 416, one or more sensor devices directly connected to the security device 402, and/or the I/O interface 410) and/or one or more criteria determined from the sensor data to determine a threshold duration based on the received sensor data. In some embodiments, the first machine learning model 442 may determine a first threshold duration based, at least in part, on one or more criteria determined for an entity detected in the sensor data 422 of the security device 402. In some examples, the security device 402 can determine, using the first machine-learning model 442, and based on first sensor data of an entity (e.g., sensor data and/or one or more criteria of an entity that are determined from sensor data), a first threshold duration correlation that corresponds to the entity detected in the sensor data 422.

For example, the one or more processors 406 can execute a first machine-learning model 442 that receives the sensor data collected by one or more of the sensors 416 as its input and, as an output, determines the first threshold duration of the entity's presence that will cause the security device 400 to execute one or more actions. In some examples, the first machine-learning model may be trained and utilized to identify, lookup, determine, generate and/or otherwise provide the first threshold duration that indicates the amount of time before the presence of the corresponding entity (or entities) will cause the security device 402 to execute one or more actions. In some examples, the first machine-learning model 442 may be trained by applying the machine-learning model 442 to historical data including past sensor data 422 capturing one or more different entities and/or persons, which correspond to various entity criteria and various entity positions (e.g., inside of one or more zones, defined for the field of view of one or more sensors such as, for example, an area around an entry to a home, a window, and the like). In some implementations, determining the first threshold duration may include identifying one or more suspicious criteria of an entity, which may be associated with corresponding periods of time (e.g., a shorter threshold duration when an entity holding a weapon is detected compared to a longer threshold duration for an entity detected with criteria associated with a neighbor or family member). Additionally, in some examples determining the first threshold duration may be based, at least in part, on determining one or more characteristics, or other associated information, of the entity including, for example, whether the entity is a known or unknown person, the position of the entity relative to one or more zones, and/or one or more of the entity's clothing, height, girth, weight, hair color, gait, profession, identity, and/or other characteristics.

The second machine learning model 444 may receive, utilize, and/or process sensor data collected by one or more sensor devices (e.g., collected by one or more sensor devices 416, collected by the security device 402, received via the network 414 and/or the I/O interface 410, and/or stored in memory 404) and/or one or more criteria determined from the sensor data to determine a threshold duration based on the received sensor data. In some embodiments, the second machine learning model 444 may determine a second threshold duration based, at least in part, on one or more parameters of a zone or region (e.g., a second zone) inside the field of view of one or more sensor devices. In some examples, the security device 402 can determine a second threshold duration using the second machine-learning model 444 and one or more parameters of a zone in which an entity has been detected by one or more sensor devices. Further, in some examples, the security system 400 may execute an action (e.g., a deterrence action) based on a period of time, or duration, that the entity remains in the second zone satisfying and/or exceeding the second threshold duration determined by the second machine learning model 444.

For example, the one or more processors 406 can execute the second machine-learning model 442, which may receive the parameters (e.g., parameters, characteristics, settings, features, etc.) of a zone inside of which one or more entities is detected by one or more of the sensors (e.g., sensor(s) 416) and may determine (e.g., provide as an output) the second threshold duration for the entity's presence within the zone that, if satisfied, will cause the security device 400 to execute one or more actions. In some examples, the second machine-learning model 444 may be trained and utilized to identify, lookup, determine, generate and/or otherwise provide the second threshold duration that indicates the amount of time before the presence of the corresponding entity (or entities) within one or more zones will cause the security device 402 to execute one or more actions.

In some examples, the second machine-learning model 444 may be trained by applying the second machine-learning model 444 to historical data including past sensor data 422 for one or more different entities and/or persons within one or more zones with one or more corresponding parameters (e.g., priority and/or sensitivity levels, distance from one or more locations, etc.). In some implementations, determining the second threshold duration may include identifying one or more parameters of a zone inside of which an entity, or entities, may be detected by one or more sensor devices and that may be used (e.g., provided to the second machine learning model 444) to determine a second threshold duration (e.g., determine a shorter threshold duration when an entity is detected near a window versus a longer threshold duration for an entity detected on a sidewalk).

Some examples can further include one or more additional machine-learning models, including, for example, one or more machine-learning models used to determine one or more characteristics of an entity, detect one or more entities captured in sensor data of one or more sensor devices, and/or determine (or identify) one or more actions to execute (e.g., by the security system 400).

The action engine 446 may determine and/or identify one or more actions to execute via the security system 400 and/or one or more other devices of the security system 400. For example, the action engine 446 may determine that an entity's presence within a zone satisfies a threshold duration (e.g., a first threshold duration determined by the first machine learning model 442) and, as a result, cause the security device 402 and/or the security system 400 to execute one or more actions. Accordingly, in some embodiments, the action engine 446 may identify one or more actions to be executed based on, or in response to, one or more outputs of the first machine-learning model 442, the second machine-learning model 446, and/or one or more sensor devices (e.g., sensor devices 416). For example, the action engine 446 may determine an action to be executed by the security device 402 and/or the security system 400 such as to turn on one or more lights, play one or more sounds, initiate one or more user routines, notify one or more user devices, and the like (e.g., send a notification from the security device 402 using over the network 414).

The operation engine 448 may perform features of the security device 402 that are not more specifically described herein. For example, the operation engine 448 may operate an operating system for the security device 402, transport data on the system bus 412, add/remove data from the data store 420, perform/enable the described communications with the one or more sensor devices 416 and/or the user device 418 via the network 414, etc.

The engines 440 may run multiple operations concurrently or in parallel by or on the one or more processor(s) 406. In some embodiments, portions of the disclosed modules, components, and/or facilities are embodied as executable instructions stored in hardware or in firmware, or stored on a non-transitory, machine-readable storage medium. The instructions may comprise computer code that, when executed by the one or more processor(s) 406, cause the security device 402 to implement certain processing steps, procedures, and/or operations, as disclosed herein.

The functions of the security device 402 have been discussed in terms of engines 440 in the memory 404, which is a description that is given by example and not by way of limitation. Persons having ordinary skill in the art will recognize that any of the engines 440 may operate using any elements (either alone or in combination) of the security device 402, including (but not limited to) the memory 404, the processor(s) 406, the network/COM interface 408, the I/O interface 410, and the system bus 412. Further, persons having ordinary skill in the art will recognize that the engines 440 may operate using other elements not shown herein (e.g., a custom computer chip with firmware to operate all or part of one or more of the engines 440). Further, it is contemplated that the engines 440 may include additional functionality other than what has been described.

The memory 404 of the security device 402 may store data in a static manner. For example, the memory 404 may comprise, e.g., a hard disk capable of storing data even during times when the security device 402 is not powered on. The memory 404 may also store data in a dynamic manner. For example, the memory 404 may comprise Random Access Memory (RAM) storage configured to hold engines (including engines 440). The memory 404 may include static RAM, dynamic RAM, flash memory, one or more flip-flops, ROM, CD-ROM, DVD, disk, tape, or magnetic, optical, or other computer storage medium, including at least one non-volatile storage medium. The memory 404 is capable of storing machine-readable and -executable instructions that the one or more processor(s) 406 are capable of reading and executing. The memory 404 may be local to the security device 402 and may comprise a memory module or subsystem remote from security device 402 and/or distributed over a network (including the network 414).

The one or more processor(s) 406 of the security device 402 may perform the functionalities already described herein. In addition, the processors 406 may perform other system control tasks, such as controlling data flows on the system bus 412 between the memory 404, the network/COM interface 408, and the I/O interface 410. The details of these (and other) background operations may be defined in operating system instructions (not shown) upon which the one or more processor(s) 406 operate.

The one or more processor(s) 406 may include one or more general purpose devices, such as an Intel®, AMD®, or other standard microprocessor; and/or a special purpose processing device, such as ASIC, SoC, SiP, FPGA, PAL, PLA, FPLA, PLD, or other customized or programmable device. The one or more processor(s) 406 may perform distributed (e.g., parallel) processing to execute or otherwise implement functionalities of the present embodiments. The one or more processor(s) 406 may run a standard operating system and perform standard operating system functions.

The network/COM interface 408 of the security device 402 may be connected to a network 414 and may act as a reception and/or distribution device for computer-readable instructions. This connection may facilitate the transfer of information (e.g., computer-readable instructions) from the security device 402 to and from the one or more sensor devices 416. The network/COM interface 408 may facilitate communication with other computing devices and/or networks, such as the Internet and/or other computing and/or communications networks. The network/COM interface 408 may be equipped with conventional network connectivity, such as, for example, Ethernet (IEEE 602.3), Token Ring (IEEE 602.5), Fiber Distributed Datalink Interface (FDDI), or Asynchronous Transfer Mode (ATM). Further, the computer may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The I/O interface 410 may comprise any mechanism allowing an operator to interact with and/or provide data to the security device 402. For example, the I/O interface 410 may include one or more microphones, one or more cameras and/or imaging sensors, one or more radar sensors, one or more infrared imaging sensors, one or more LIDAR sensors, and the like, in the manner described above. Further, the I/O interface 410 may include a keyboard, a mouse, a monitor, and/or a data transfer mechanism, such as a disk drive or a flash memory drive. The I/O interface 410 may allow an operator to place information in the memory 404, or to issue instructions to the security device 402 to perform any of the functions described herein.

Some embodiments can include an apparatus that comprises: one or more sensor devices, including one or more image capture devices to capture image data of an environment; and one or more processors configured to: detect, the one or more sensor devices, the presence of an entity within a first zone inside a field of view of the one or more image capture devices; determine that the entity corresponds to one or more criteria; determine, using a first machine-learning model, a first threshold duration based at least in part on the one or more criteria that correspond to the entity; determine a duration the entity remains in the first zone after detection by the one or more sensor devices; and execute a deterrence action based on the duration and the first threshold duration.

In some of those embodiments, the one or more processors can be further configured to: identify a default duration based at least in part on the first zone inside the field of view of the one or more image capture devices, and the first threshold duration can be less than the identified default duration. And in some embodiments the one or more processors can be further configured to: detect, using the one or more sensor devices, the presence of one or more additional entities within the first zone inside the field of view of the one or more image capture devices; determine that the one or more additional entities correspond to one or more criteria; determine a duration that the one or more additional entities have remained in the first zone after detection by the one or more sensor devices, wherein the first threshold duration can also be determined based on the detected one or more additional entities and the one or more criteria that correspond to the one or more additional entities and wherein the deterrence action can also be based on the duration that the one or more additional entities have remained in the first zone.

In some embodiments the one or more processors can be further configured to: detect, using the one or more sensor devices, the presence of the entity within a second zone inside the field of view of the one or more image capture devices; and determine, using a second machine-learning model, a second threshold duration based on parameters of the second zone and the one or more criteria that correspond to the entity, wherein the one or more processors can execute the deterrence action based on the duration meeting the second threshold duration, and the second threshold duration is shorter than the first threshold duration.

Further, in some embodiments the determined one or more criteria that correspond to the entity can include a behavior of the entity. And in some embodiments, the determined one or more criteria that correspond to the entity can include a distance between the entity and a location. Additionally, in some of those embodiments, the location can be the location of one or more of the one or more sensor devices. And in one or more of those embodiments the location can be within the second zone. In some embodiments, the location can be an entrance to a dwelling. In some examples, the one or more criteria that correspond to the entity can include a distance between the entity and an object. In one or more embodiments, the one or more criteria that correspond to the entity can include a weapon in the entity's possession.

In some embodiments, the one or more criteria that correspond to the entity can include a direction of travel of the entity. In some embodiments, the determined one or more criteria that correspond to the entity can include a velocity of the entity. Additionally, in some embodiments, the one or more processors can be further configured to execute a default deterrence action based on the duration meeting the second threshold duration and execute a first escalated action based on the duration meeting the first threshold duration. In some of those embodiments, the one or more processors can be still further configured to execute a second escalated action based on the duration meeting a default duration.

Some embodiments can include a method comprising: detecting, using one or more sensor devices including one or more image capture devices to capture image data of an environment, a presence of an entity within a first zone inside a field of view of the one or more image capture devices; determining, by one or more processors, that the entity corresponds to one or more criteria; determining, by the one or more processors, a first threshold duration based at least in part on the one or more criteria that correspond to the entity; monitoring, by the one or more processors, based on sensor data from the one or more sensor devices, a duration the entity remains in the first zone after detection by the one or more sensor devices; and executing a deterrence action based on the duration and the first threshold duration.

Some of those embodiments can further comprise identifying, by the one or more processors, a default duration based at least in part on the first zone inside the field of view of the one or more image capture devices, wherein the first threshold duration is shorter than the identified default duration. And some embodiments further comprise detecting, using the one or more sensor devices, the presence of one or more additional entities within the first zone inside the field of view of the one or more image capture devices; determining, by the one or more processors, that the one or more additional entities correspond to one or more criteria; and determining, by the one or more processors, that the one or more additional entities have remained in the first zone for the first threshold duration after detection by the one or more sensor devices, wherein the first threshold duration is also determined based on the detected one or more additional entities and the one or more criteria that correspond to the one or more additional entities.

Some embodiments can further comprise: detecting, using the one or more sensor devices, the presence of the entity within a second zone inside the field of view of the one or more image capture devices; and determining, by the one or more processors, a second threshold duration based on parameters of the second zone and the one or more criteria that correspond to the entity, wherein the one or more processors execute the deterrence action based on the duration meeting the second threshold duration, and wherein the second threshold duration is shorter than the first threshold duration.

And in some embodiments, the determined one or more criteria that correspond to the entity can include a behavior of the entity. In some embodiments, the determined one or more criteria that correspond to the entity can include a distance between the entity and a location. In some of those embodiments, the location is the location of one or more of the one or more sensor devices. In some embodiments, the one or more identified criteria that correspond to the second zone can include the location and wherein the location is within the second zone. And in some of those embodiments, the location can be an entrance to a dwelling.

In some embodiments, the one or more criteria that correspond to the entity can include a distance between the entity and an object. And in some embodiments, the one or more criteria that correspond to the entity can include a weapon in the entity's possession. Further, in some embodiments, the one or more criteria that correspond to the entity can include a direction of travel of the entity. In some embodiments, the one or more criteria that correspond to the entity can include a velocity of the entity.

In some embodiments, executing a deterrence action comprises executing a default deterrence action based on the duration meeting the second threshold duration; and executing a first escalated action based on the duration meeting the first threshold duration. And in some of those embodiments, executing the deterrence action can further comprise executing a second escalated action based on the duration meeting a default duration.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. An apparatus comprising:
one or more sensor devices, including one or more image capture devices to capture image data of an environment; and
one or more processors configured to:
detect, using the one or more sensor devices, the presence of an entity within a first zone of the environment;
determine that the entity corresponds to one or more criteria;
determine a first threshold duration based at least in part on the one or more criteria that correspond to the entity;
determine a duration the entity remains in the first zone after detection by the one or more sensor devices; and
execute a deterrence action based on the duration and the first threshold duration.

2. The apparatus of claim 1, wherein the one or more processors are further configured to:
identify a default duration based at least in part on the first zone,
wherein the first threshold duration is less than the identified default duration.

3. The apparatus of claim 1, wherein the one or more processors are further configured to:
detect, using the one or more sensor devices, the presence of one or more additional entities within the first zone;
determine that the one or more additional entities correspond to one or more criteria;
determine a duration that the one or more additional entities have remained in the first zone after detection by the one or more sensor devices,
wherein the first threshold duration is also determined based on the detected one or more additional entities and the one or more criteria that correspond to the one or more additional entities, and
wherein the deterrence action is also based on the duration that the one or more additional entities have remained in the first zone.

4. The apparatus of claim 1, wherein the one or more processors are further configured to:
detect, using the one or more sensor devices, the presence of the entity within a second zone of the environment; and
determine a second threshold duration based on parameters of the second zone and the one or more criteria that correspond to the entity,
wherein the one or more processors execute the deterrence action based on the duration meeting the second threshold duration, and
wherein the second threshold duration is shorter than the first threshold duration.

5. The apparatus of claim 4, wherein to execute the deterrence action, the one or more processors are further configured to:
execute a default deterrence action based on the duration meeting the second threshold duration; and
execute a first escalated action based on the duration meeting the first threshold duration.

6. The apparatus of claim 5, wherein to execute the deterrence action, the one or more processors are further configured to:
execute a second escalated action based on the duration meeting a default duration.

7. The apparatus of claim 1, wherein the determined one or more criteria that correspond to the entity include a behavior of the entity.

8. The apparatus of claim 1, wherein the determined one or more criteria that correspond to the entity include a distance between the entity and a location.

9. The apparatus of claim 8, wherein the location is the location of one or more of the one or more sensor devices.

10. The apparatus of claim 8, wherein the location is within the second zone.

11. The apparatus of claim 1, wherein the one or more criteria that correspond to the entity include a distance between the entity and an object.

12. The apparatus of claim 1, wherein the one or more criteria that correspond to the entity include a direction of travel of the entity.

13. The apparatus of claim 1, wherein the determined one or more criteria that correspond to the entity include a velocity of the entity.

14. A method comprising:
detecting, using one or more sensor devices including one or more image capture devices to capture image data of an environment, a presence of an entity within a first zone within the environment;
determining, by one or more processors, that the entity corresponds to one or more criteria;
determining, by the one or more processors, a first threshold duration based at least in part on the one or more criteria that correspond to the entity;
monitoring, by the one or more processors, based on sensor data from the one or more sensor devices, a duration the entity remains in the first zone after detection by the one or more sensor devices; and
executing a deterrence action based on the duration and the first threshold duration.

15. The method of claim 14, further comprising:
identifying, by the one or more processors, a default duration based at least in part on the first zone,
wherein the first threshold duration is shorter than the identified default duration.

16. The method of claim 14, further comprising:
detecting, using the one or more sensor devices, the presence of one or more additional entities within the first zone;
determining, by the one or more processors, that the one or more additional entities correspond to one or more criteria; and
determining, by the one or more processors, that the one or more additional entities have remained in the first zone for the first threshold duration after detection by the one or more sensor devices,
wherein the first threshold duration is also determined based on the detected one or more additional entities and the one or more criteria that correspond to the one or more additional entities.

17. The method of claim 14, further comprising:
detecting, using the one or more sensor devices, the presence of the entity within a second zone inside the field of view of the one or more image capture devices; and
determining, by the one or more processors, a second threshold duration based on parameters of the second zone and the one or more criteria that correspond to the entity,
wherein the one or more processors execute the deterrence action based on the duration meeting the second threshold duration, and
wherein the second threshold duration is shorter than the first threshold duration.

18. The method of claim 14, wherein the determined one or more criteria that correspond to the entity include a behavior of the entity.

19. The method of claim 14, wherein the determined one or more criteria that correspond to the entity include a distance between the entity and a location.

20. The method of claim 14, wherein the one or more criteria that correspond to the entity include a direction of travel of the entity.

21. The apparatus of claim 14, wherein the one or more criteria that correspond to the entity include a velocity of the entity.
